(19) United States
(12) Patent Application Publication
(10) Pub. No.: US 2026/0115751 A1
(43) Pub. Date: Apr. 30, 2026

(54) A SUPPORT STAND SYSTEM FOR AUTOMOTIVE PARTS

(71) Applicant: US Auto Supply, Elgin, IL (US)

(72) Inventor: Brian James O'Reilly, Pingree Grove, IL (US)

(73) Assignee: US Auto Supply, Elgin, IL (US)

(21) Appl. No.: 18/933,974

(22) Filed: Oct. 31, 2024

(51) Int. Cl. B05B 13/02; F16M 11/08; F16M 11/20; F16M 11/28

(52) U.S. Cl. CPC B05B 13/0285; F16M 11/08; F16M 11/2021; F16M 11/28

(57) ABSTRACT

A support stand system for painting components comprising a mobile stand base, a vertical support shaft, and at a pivot head subassembly removably coupled to the proximal end of the vertical support shaft.

### FIELD

The preferred implementation relates to multifunctional stand systems with a plurality of attachments for supporting parts of automotives for repair work and/or painting purposes.

### BACKGROUND

Painting services are essential in many facilities engaged in activities such as auto body repair and auto restoration. In such facilities, it is often necessary to paint all or multiple components.

In a typical automotive part painting facility, a separate enclosed painting booth is usually provided to be used by paint technicians to paint different automotive parts. The painting booth helps to control the painting environment and provide necessary lighting and ventilation for the painting application. The painting booth also provides ample space for the paint technicians to move the multiple automotive parts, such as fenders, in multiple directions/orientations and carry out the right painting job required for each of the multiple parts that need to be painted.

A major factor in achieving skillful painting results is the ability to arrange and orient the multiple automotive parts in a desired manner needed by each of the individual parts while painting. To achieve this, support stands are commonly employed by paint technicians. Support stands for mounting automotive parts to be painted would ideally be mobile and properly align each part, enabling access to all the dimensions of the parts for ease of painting. However, the presently available support stands do not allow for mounting of multiple automotive parts for painting while also providing easy alignment/orientation for each of the components and mobility to easily move the support stand across different types of floor surfaces (i.e., floor of the painting booth).

Presently available support stands are limited in their functionality and are subject to numerous faults. Despite allowing mounting of multiple automotive parts simultaneously, presently available support stands still lack in mobility and alignment/orientation for each part, independent of other parts, during the painting job.

There remains an unresolved and unfulfilled need in the art for a more efficient mobile support stand system for painting multiple automotive parts simultaneously, while also enabling the appropriate alignment/orientation of the each of the parts, independent of other parts.

### SUMMARY

Disclosed herein are approaches for addressing various of the problems and shortcomings of the state of the art, as identified above. More particularly, disclosed herein are support stand systems for mounting and painting multiple automotive parts.

According to a first aspect of the present disclosure, there is provided a support stand system for a mobile stand base including at least one support leg to move the support stand system between locations, a vertical support shaft comprising a proximal end and a distal end, the distal end removably coupled to the mobile stand base and a pivot head subassembly removably coupled to the proximal end of the vertical support shaft. The pivot head subassembly comprises a pivot head comprising at least one rail rod, the pivot head configured to rotate about an axis perpendicular to the vertical support shaft, at least one sliding elbow subassembly movably coupled to the at least one rail rod of the pivot head, and at least one pivot support arm slidably coupled to the at least one sliding elbow subassembly, the at least one pivot support arm being configured to support at least one automotive part.

### BRIEF DESCRIPTION OF THE DRAWINGS

FIG. 1 shows a perspective view of an exemplary aspect of a support stand system.

FIG. 2A shows a perspective view of an exemplary implementation of a pivot head according to an aspect of the support stand system.

FIG. 2B shows an exploded view of an exemplary implementation of a pivot head according to an aspect of the support stand system.

FIG. 3A shows a perspective view of an exemplary implementation of a sliding elbow subassembly according to an aspect of the support stand system.

FIG. 3B shows an exploded view of an exemplary implementation of a sliding elbow subassembly according to an aspect of the support stand system.

FIG. 4A shows a perspective view of an exemplary implementation of a pivot support arm according to an aspect of the support stand system.

FIG. 4B shows an exploded view of an exemplary implementation of a pivot support arm according to an aspect of the support stand system.

FIG. 5A shows a perspective view of an exemplary implementation of an extension arm according to an aspect of the support stand system.

FIG. 5B shows an exploded view of an exemplary implementation of an extension arm according to an aspect of the support stand system.

FIG. 6A shows a perspective view of an exemplary implementation of a vertical support shaft according to an aspect of the support stand system.

FIG. 6B shows an exploded view of an exemplary implementation of a vertical support shaft according to an aspect of the support stand system.

FIG. 7 shows a perspective view of an exemplary implementation of a mobile stand base according to an aspect of the support stand system.

### DETAILED DESCRIPTION

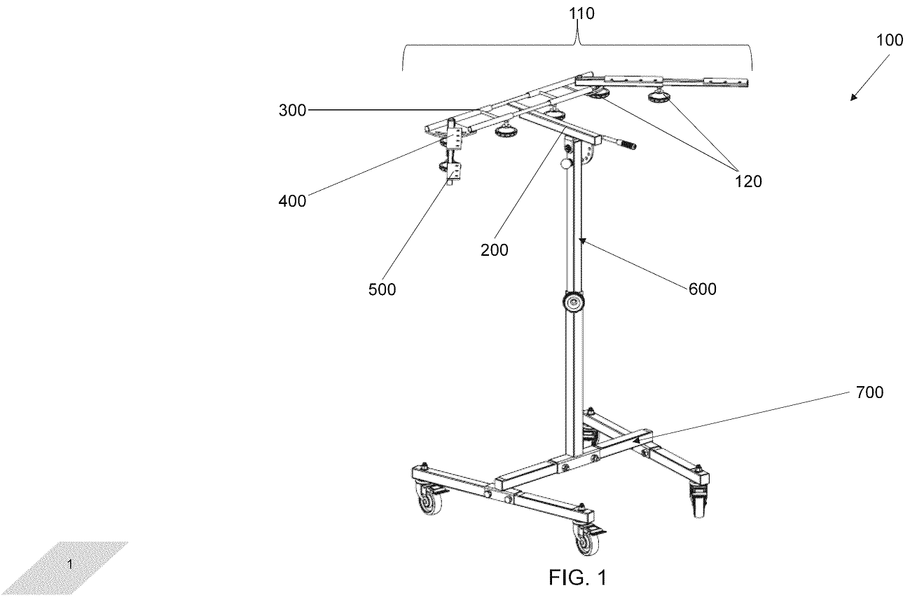

Referring to the drawings, FIG. 1 shows a perspective view of an exemplary aspect of a support stand system 100. FIG. 1 also presents the primary structural components of the support stand system 100. These include a pivot head subassembly 110 movably coupled to a vertical support shaft 600, and a mobile base stand 700 also coupled to the vertical support shaft 600. The pivot head subassembly 110 includes a pivot head 200 movably coupled to the vertical support shaft 600, at least one sliding elbow subassembly 300 slidably coupled to the pivot head 200, and at least one pivot support arm 400 slidably coupled to the at least one sliding elbow subassembly 300. In some aspects of the support stand system 100, such as the exemplary aspect of the support stand system 100 in FIG. 1, the pivot head subassembly 110 further includes at least one extension arm 500 movably coupled to the at least one pivot support arm 400. The at least one pivot support arm 400 and the at least one extension arm 500 are configured to hold automotive parts (e.g., automotive fenders) to be painted. The components that can be mounted onto the at least one pivot support arm 400 and the at least one extension arm 500 can include automotive fenders. The mobile base stand 700 is configured to confer mobility to the support stand system 100 which could allow the paint technician to move the support stand system 100 across different floor surfaces. In some aspects, the support stand system 100 can be made with square steel tubing. In some aspects, the square steel tubing used is a 16-gauge square steel tubing. In some aspects, the support stand system 100 can include a surface coating, such as powder coating, to prevent surface degradation during chemical exposure (e.g., automotive part painting).

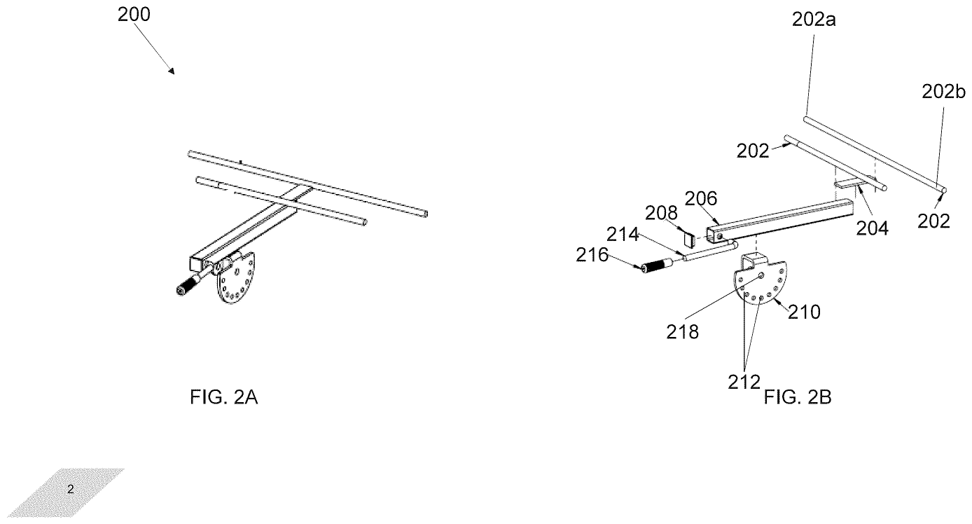

Referring to FIGS. 2A-2B, a perspective view and an exploded view of an exemplary implementation of the pivot head 200 according to an aspect of the support stand system 100, are shown respectively. The pivot head 200, which includes at least one rail rod 202 disposed on a central shaft 206, is movably coupled to the vertical support shaft 600. The pivot head 200 further comprises a pivot plate 210 mechanically coupled to the central shaft 206, and a handle 214 coupled to the central shaft 206. In some implementations, the pivot head 200 is coupled to the vertical support shaft 600 via a bushing (not shown in FIG. 2) inserted through a bushing insertion point 218 disposed on the pivot plate 210 such that the pivot head 200 is pivoted and is configured to move about the bushing. In some implementations, the handle 214 can include a grip 216 disposed on a distal end of the handle 214. In the implementation of the pivot head 200 shown in FIGS. 2A-2B, the handle 214 can be configured to pivot the pivot head 200 about an axis perpendicular to vertical support shaft 600 at a plurality of pivot angles. In this implementation, each plurality angle of the plurality of angles at which the pivot head 200 can pivot to is determined by placement of a plunger 606 (explained in the paragraphs below) in each of the plurality of plunger insertion points 212 disposed on the pivot plate 210.

The at least one rail rod 202 can be mechanically coupled to the central shaft 206 directly via welding. As shown in FIGS. 2A-2B, the at least one rail rod 202 can also be mechanically coupled to the central shaft 206 via a rod brace weld 204. As shown in FIGS. 2A-2B, the at least one rail rod 202 comprises two ends 202a, 202b. The at least sliding elbow subassembly 300 is configured to slidably couple to one of the two ends 202a, 202b of the at least one rail rod 202. A length of the at least one rail rod 202 can determine a sliding distance of the at least one sliding elbow subassembly 300, which is configured to slide along the length of the at least one rail rod 202. In some implementations, the at least one rail rod 202 can include more than one rail rod 202, where each rail rod 202 can have a different length in comparison to the other.

In the implementation of the pivot head 200 presented in FIGS. 2A-2B, the at least one rail rod 202 can include two rail rods 202 disposed on the central shaft 206 via the brace 204. In this implementation, the central shaft 206 further includes a plug 208 disposed on a distal end of the central shaft 206.

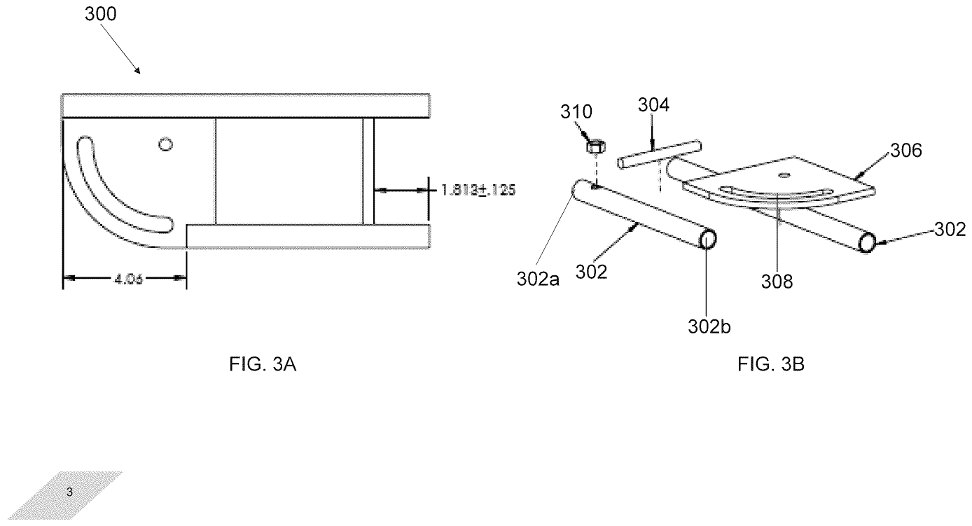

Referring to FIGS. 3A-3B, a perspective view and an exploded view of an exemplary implementation of the sliding elbow subassembly 300 according to an aspect of the support stand system 100, are shown respectively. The primary components of the sliding elbow subassembly 300 include at least one hollow tube 302 comprising a proximal end 302a and a distal end 302b and an elbow pivot plate 306 coupled to the at least one hollow tube 302 proximal to the distal end 302b of the at least one hollow tube 302. The proximal end 302a of the hollow tube 302 is configured to articulate with either of the ends 202a, 202b of the rail rod 202 of the pivot head 200. In some implementations, the hollow tube 302 can further comprise a tightening nut 310 disposed proximal to the proximal end 302a of the hollow tube 300 to lock a position of the hollow tube 302 along the length of the at least one rail rod 202. In other implementations, the tightening nut 310 can be coupled to a knob 120 (shown in FIG. 1) configured to allow a user to lock the position of the hollow tube 302 along the length of the at least one rail rod 202.

In some implementations of the sliding elbow subassembly 302, such as the implementations presented in FIGS. 3A-3B, the at least one hollow tube 300 comprises two hollow tubes in which the elbow pivot plate 306 is coupled proximally to the distal end 302b of both the hollow tubes 302. In these implementations, both the hollow tubes 302 are configured to slidably couple with two rail rods 202 of the pivot head 200 (shown in the aspect of the support stand system 100 of FIG. 1). In these implementations, both the hollow tubes 302 are connected by a bridge rod 304 configured to ensure both the hollow tubes 302 slide in a parallel fashion along the two rail rods 202. In some implementations, the sliding elbow subassembly 300 can be configured to slide along the two rail rods 202 such that a distance between the pivot support 400 (explained in below paragraphs) and the central shaft 206 of the pivot head 200 can be extended between 26 inches and 38 inches (or shorter or longer) to accommodate different dimensioned automotive parts. In some implementations, both the hollow tubes 300 are of the same length.

In some implementations, such as the implementations shown in FIGS. 3A-3B, one of the hollow tubes 300 is shorter than the other to accommodate the elbow pivot plate 306 shaped as a quadrant. In other implementations, the elbow pivot plate 306 can be shaped differently than a quadrant. In some implementations, the shape of the elbow pivot plate 306 can be selected from a group of shapes including square, rectangle, circle, and semicircle, or other known shapes. In the implementations shown in FIGS. 3A-3B, the elbow pivot plate comprises a slot 308 configured to articulate with the at least one pivot support arm 400 and allow the at least one pivot support arm 400 to move along a length of the slot 308. In some implementations, the at least one pivot support arm 400 can be slidably coupled to the slot 308 with the tightening nut 310 coupled to the knob 120 (as shown in FIG. 1), where actuation of the knob 120/tightening nut 310 can lock the at least one pivot support arm 400 at a position along the length of the slot 308.

In some aspects of the support stand system 100, such as the aspect presented in FIG. 1, the pivot head 100 can comprise two sliding elbow subassemblies 300, mirroring each other, and slidably coupled to both ends 202a, 202b of two rail rods 202 of the pivot head 200.

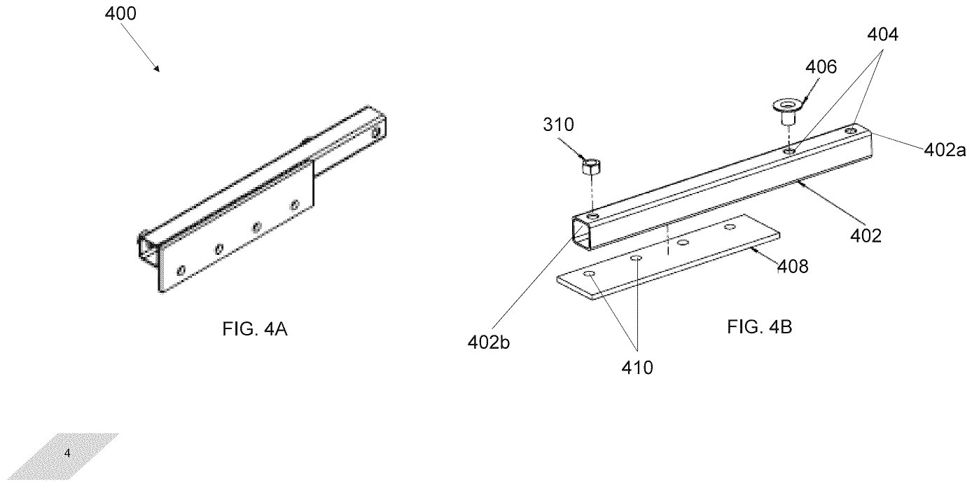

Referring to FIGS. 4A-4B, a perspective view and an exploded view of an exemplary implementation of the pivot support arm 400 according to an aspect of the support stand system 100, are shown respectively. The pivot support arm 400 includes a shaft 402 with a proximal end 402a and a distal end 402b and a base plate 408 mechanically coupled to the shaft 402 proximal to the distal end 402b. The pivot support arm 400 is configured to slidably couple to the slot 308 of the elbow pivot plate 306 via a bolt 406 placed through a bolt insertion point 404 disposed proximal to the proximal end 402a of the shaft 402. The bolt 406 can be locked in a user-determined position along the slot 308 of the elbow pivot plate 306 via the tightening nut 310 (not shown in FIGS. 4A-4B). The pivot support arm 400 is also configured to rotate about the vertical axis of the vertical support shaft 600. In some implementations, the pivot support arm 400 is configured to rotate 90 degrees about the vertical axis of the vertical support shaft 600. In some implementations such as the implementations presented in FIGS. 4A-4B, the shaft 402 can be hollow and be configured to articulate with the at least one extension arm 500 (as shown in FIG. 1). In these implementations, the shaft 402 can further include the tightening nut 310 disposed at the distal end 402b and configured to lock a position of the extension arm 500 along a length of the shaft 402. In some implementations, the tightening nut 310 can be coupled with a knob 120 (as shown in FIG. 1) to enable the user to tighten or loosen the tightening nut 310 and move the extension arm 500 along the length of the shaft 402.

In some implementations (such as FIG. 4B), the shaft 406 can include a plurality of bolt insertion points 406 configured to allow the user to extend the pivot support arm 400 further or closer from the slot 308 of the elbow pivot plate. In some implementations, the base plate 408 is coupled to the shaft 406 via welding. The base plate 408 can be configured to include at least one part holder insertion point 410 for holding an automotive part to be painted by securing the part to the at least one part holder insertion point 410 with the bolt 406. In some implementations, the base plate 408 comprises a plurality of part holder insertion points 410, where each part holder insertion point 410 is configured to hold an automotive part.

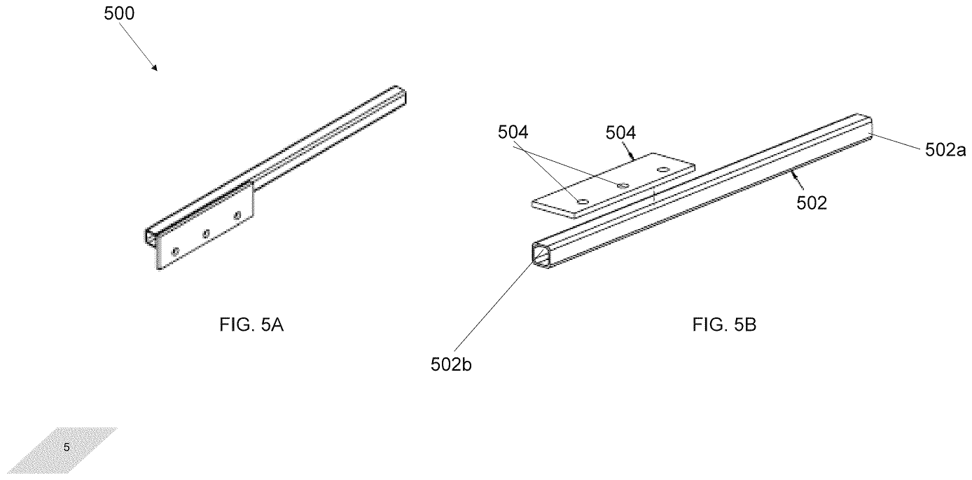

Referring to FIGS. 5A-5B, a perspective view and an exploded view of an exemplary implementation of the at least one extension arm 500 according to an aspect of the support stand system 100, are shown respectively. The at least one extension arm 500 includes an extension arm shaft 502 with a proximal end 502a and a distal end 502b and a base plate 504 mechanically coupled to the extension arm shaft 502 proximal to the distal end 502b. The proximal end 502a of the extension arm shaft 502 is configured to slidably couple to the distal end 402b of the shaft 402 of the pivot support arm 400. In these implementations, the extension arm shaft 502 can be configured to move along the shaft 402 of the pivot support arm 400.

In some implementations, the base plate 504 is coupled to the at least one extension arm shaft 406 via welding. The base plate 504 can be configured to include at least one part holder insertion point 506 for also holding an automotive part to be painted by securing the part to the at least one part holder insertion point 506 with the bolt 406 (not shown in FIGS. 5A-5B). In some implementations, the base plate 504 comprises a plurality of part holder insertion points 506, where each part holder insertion point 506 is configured to hold an automotive part.

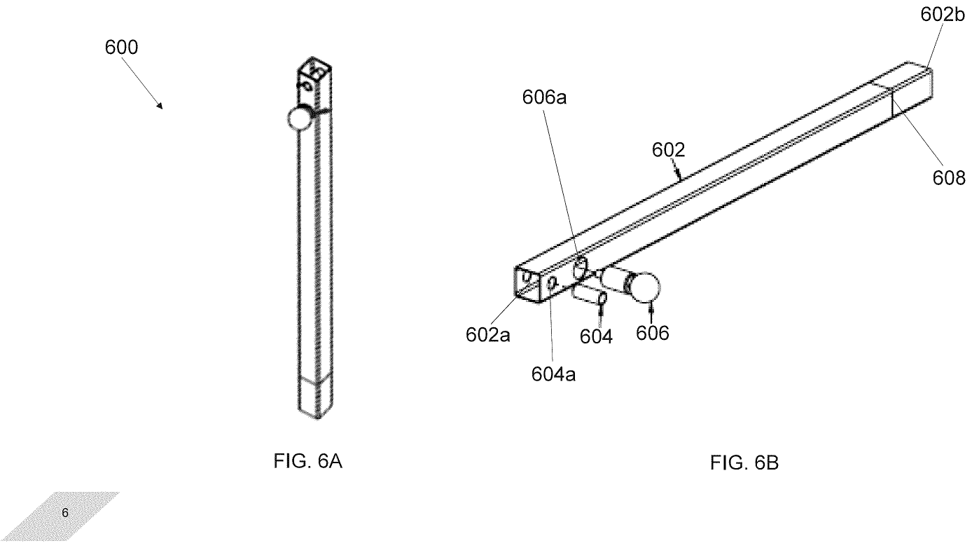

Referring to FIGS. 6A-6B, a perspective view and an exploded view of an exemplary implementation of the vertical support shaft 600 according to an aspect of the support stand system 100, are shown respectively. In some implementations, the vertical support shaft 600 can be configured to be height adjustable. In some implementations, the vertical support shaft 600 can be height adjusted such that the support stand system 100 comprises a height range between 40 inches and 62 inches tall, or other heights. In the implementation of the vertical support shaft 600 shown in FIGS. 6A-6B, a distal end 602b of the vertical support shaft 600 is configured to couple to a vertical support shaft connector 708 (explained in the paragraphs below) to connect the vertical support shaft 600 to the mobile stand base 700. In this implementation, the vertical support shaft 600 comprises a stop plate 608 configured to limit a depth at which the vertical support shaft 600 can travel within the vertical support shaft connector 708.

In the implementation of the vertical support shaft 600 shown in FIGS. 6A-6B, the vertical support shaft further includes an insertion point 604a (which lines up with the bushing insertion point 218 disposed on the pivot plate 210) disposed proximally to a proximal end 602a of the vertical support shaft 600. The insertion point 604a (configured to line up with the bushing insertion point 218 disposed on the pivot plate 210) configured to receive a bushing 604 and allow the pivot head 200 to rotate about the bushing 604. In this implementation, the vertical support shaft 600 further comprises a plunger point 606 (configured to line up with each of the plunger insertion points 212 of the pivot plate 212 of the pivot head 200) disposed proximally to the proximal end 602a of the vertical support shaft 600. The plunger point 606a is configured to receive a plunger 606 configured to secure the pivot head 200 at each plurality angle of the plurality of angles at which the pivot head 200 can pivot to. In some implementations, the plunger 606 can be a retractable plunger comprising a spring configured to automatically return the plunger to an inserted position after being retracted temporarily when moving the pivot head 200 about the bushing 604.

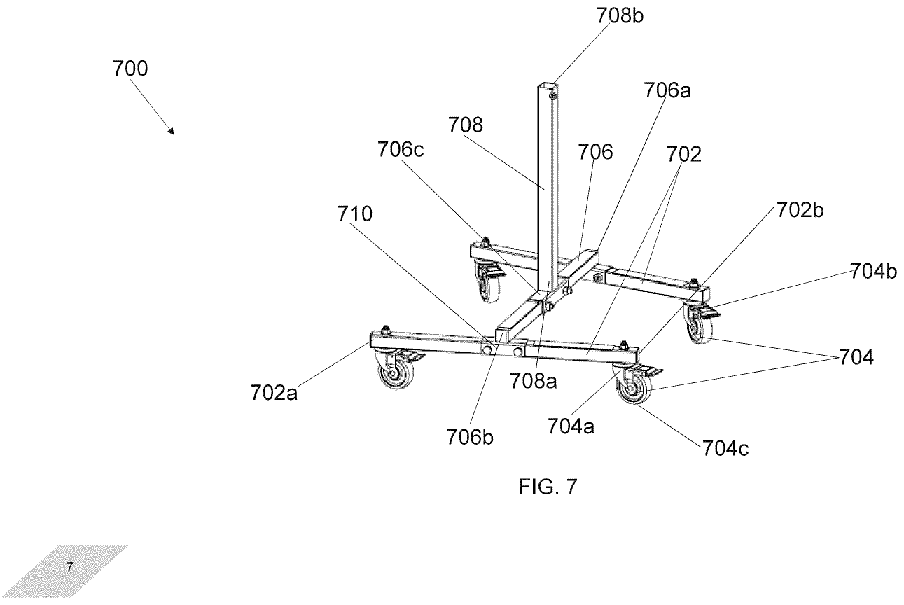

Referring to FIG. 7, a perspective view of the mobile stand base 700 according to an aspect of the support stand system 100 is shown. The mobile stand base 700 includes at least one support leg 702 with two ends 702a,b and at least one lockable caster 704 disposed on each of the two ends 702a,b of the at least one support leg 702. The at least one support leg 702 can include more than one lockable caster 704. In some implementations of the mobile stand base 700, such as the implementation of FIG. 7, the mobile stand base 700 includes two support legs 702 connected by a bridge 706, where the two ends 706a,b of the bridge 706 are coupled to the two support legs 702 via brackets 710 disposed on the two ends 706a,b. The bridge brackets 710 can coupled to the support legs via welding. The bridge brackets 710 can also be coupled to the support legs 702 via screws as shown in FIG. 7.

In the implementation of the mobile stand base 700 presented in FIG. 7, the mobile stand base 700 further comprises a vertical support shaft connector 708 disposed on the bridge 706 connecting the two support legs 702. A proximal end 708a of the vertical support shaft connector 708 comprises a bracket 706c configured for coupling to the bridge 706 via screws. The bracket 706c can be coupled to the bridge 706 via welding. The distal end 708b is configured to removably couple to the vertical support shaft 600. In other implementations, the distal end 708b can be configured to be coupled to the vertical support shaft 600 via a screw (not shown in FIG. 7) disposed on the distal end 708b and configured to articulate with a corresponding thread disposed on the vertical support shaft 600. In some implementations, a depth of the vertical support shaft 600 that can be accommodated in the vertical support shaft connector 708 can be limited. by the stop plate (not shown in FIGS. 6A-7) disposed in the vertical support shaft 600.

In the implementation of the mobile stand base 700 presented in FIG. 7, the at least one lockable caster 704 comprises a swivel bracket 704a configured to allow rotation of the at least one lockable caster, a wheel brake 704b, and a rotatable wheel 704c contained within the swivel bracket 704a. The wheel brake 704b disposed on the swivel bracket 704a can be configured to restrict motion of the rotatable wheel 704c. When the wheel brake 704b is an engaged position, the wheel brake 704b can be configured to directly interface with the rotatable wheel 704c and restricts the motion of the rotatable wheel 704c. When the wheel brake 704c is a disengaged position, the wheel brake 704b can be configured to not interface with the rotatable wheel 704c and therefore not impede motion of the rotatable wheel 704c. In some implementations of the at least one lockable caster 704, the wheel brake 704b can be a foot brake comprising a foot pedal (not shown in the FIG. 7) and configured to switch the wheel brake 704b between the engaged and disengaged positions with the actuation of the foot pedal.

While the advantages and preferred embodiments of the present invention have been described hereinbefore, those skilled in the art should be understood that the above are merely several illustrative embodiments of the present invention without limiting the scope thereof, wherein various modifications, alterations or substitutions may be made to the specific components of the embodiments without departing from the spirit and scope of the invention and its claims.

What is claimed is:

1. A support stand comprising:
a mobile stand base comprising at least one support leg, the mobile stand base being configured to move the support stand system between locations;
a vertical support shaft comprising a proximal end and a distal end, the distal end removably coupled to the mobile stand base; and
a pivot head subassembly removably coupled to the proximal end of the vertical support shaft, the pivot head subassembly comprising:
a pivot head comprising at least one rail rod, the pivot head configured to rotate about an axis perpendicular to the vertical support shaft;
at least one sliding elbow subassembly movably coupled to the at least one rail rod of the pivot head; and
at least one pivot support arm slidably coupled to the at least one sliding elbow subassembly, the at least one pivot support arm being configured to support at least one automotive part.

2. The support stand system of claim 1, wherein the mobile stand base comprises:
at least one support leg comprising two ends; and
at least one lockable caster disposed on each of the two ends of the at least one support leg.

3. The support stand system of claim 2, wherein the at least one support leg comprises two support legs connected by a bridge disposed between both support legs, wherein each of the support legs comprises at least one lockable caster.

4. The support stand system of claim 3, wherein the mobile stand base comprises a vertical support shaft connector disposed on the bridge, the vertical support shaft connector configured to removably couple to the second end of the vertical support shaft.

5. The support stand system of claim 4, wherein the vertical support shaft is configured to be height adjustable.

6. The support stand system of claim 2, wherein the at least one lockable caster comprises:
a swivel bracket configured to allow rotation of the at least one lockable caster;
a rotatable wheel contained with the swivel bracket; and
a wheel brake disposed on the swivel bracket and configured to restrict motion of the rotatable wheel in an engaged position.

7. The support stand system of claim 6, wherein the wheel brake is a foot brake comprising a foot pedal and configured to switch the wheel brake between the engaged and disengaged positions with the actuation of the foot pedal.

8. The support stand system of claim 1, wherein the pivot head comprises:
a central shaft;
two rail rods coupled to the central shaft;
a pivot plate mechanically coupled to the central shaft, the pivot plate comprising a plurality of plunger insertion points, wherein each of the plunger insertion points is configured to receive a plunger disposed on the vertical support shaft; and
a bushing insertion point disposed on the pivot plate, the bushing insertion point configured to receive a bushing and rotatably couple the pivot head to the vertical support shaft.

9. The support stand system of claim 8, wherein the pivot head further comprises a handle coupled to the central shaft, the handle configured to allow a user to rotate the pivot head about the bushing.

10. The support stand system of claim 9, wherein the vertical support shaft further comprises:
an insertion point disposed proximally to the proximal end of the vertical support shaft, the insertion point configured to:
line up with the bushing insertion point disposed on the pivot plate of the pivot head; and
receive the bushing; and
a plunger point disposed proximally to the proximal end of the vertical support shaft, the plunger point configured to:
line up with the each of the plurality of plunger insertion points disposed on the pivot plate; and
receive the plunger configured to lock the pivot head at an angle corresponding to the each of the plurality of plunger insertion points.

11. The support stand system of claim 10, wherein the plunger is a retractable plunger comprising a spring configured to automatically return the plunger to an inserted position when the plunger is retracted.

12. The support stand system of claim 1, wherein the at least one sliding elbow subassembly comprises:
at least one hollow tube comprising a proximal end and a distal end, wherein the proximal end of the at least hollow tube is configured to articulate with the at least one rail rod of the pivot head; and
an elbow pivot plate coupled to the at least one hollow tube proximally to the distal end of the at least one hollow tube, the elbow pivot plate comprising a slot configured to slidably couple to the at least one pivot support arm.

13. The support stand system of claim 12, wherein the at least one sliding elbow subassembly further comprises a tightening nut disposed proximally to the proximal end of the at least one hollow tube, the tightening nut configured to lock a position of the at least one hollow tube on the at least one rail rod of the pivot head.

14. The support stand system of claim 13, wherein the tightening nut is coupled to a knob, wherein actuation of the knob locks the position of the at least one hollow tube on the at least one rail rod of the pivot head.

15. The support stand system of claim 1, further comprising at least one extension arm coupled to the at least one pivot support arm, the at least one extension arm configured to support the at least one automotive part
